(19) United States
(12) Patent Application Publication
(10) Pub. No.: US 2026/0319835 A1
(43) Pub. Date: Oct. 15, 2026

(54) PROCESS OPERATION SYSTEM AND PROCESS OPERATION METHOD

(71) Applicant: Quanta Computer Inc., Taoyuan City (TW)

(72) Inventors: Chen-Chung LEE, Taoyuan City (TW); Chun-Hung CHEN, Taoyuan City (TW); Chien-Kuo HUNG, Taoyuan City (TW); Tsai-Hsing LU, Taoyuan City (TW); En-Chi LEE, Taoyuan City (TW)

(21) Appl. No.: 19/280,566

(22) Filed: Jul. 25, 2025

(30) Foreign Application Priority Data
Apr. 11, 2025 (TW) 114113665

(51) Int. Cl. G06F 9/48; G06F 9/54

(52) U.S. Cl. CPC G06F 9/4881; G06F 9/546

(57) ABSTRACT

A process operation system includes a queue service, a process operation platform, and an endpoint task robot. The queue service runs with containerization technology. The process operation platform stores the received tasks into the task queue of the queue service. The endpoint task robot has a connection module and performs the following operations. The endpoint task robot completes the connection with the queue of the queue service by obtaining the connection factory information pre-generated by the queue service. The endpoint task robot obtains a target task through the queue channel according to the preset authority setting. Before establishing a connection with the queue service, the endpoint task robot checks the queue connection and the queue channel. If neither exists, the endpoint task connects according to the connection factory information.

### CROSS REFERENCE TO RELATED APPLICATIONS

This application claims priority of Taiwan patent application No. 114113665, filed Apri, 11 2025, the entirety of which is incorporated by reference herein.

### TECHNICAL FIELD

The present invention relates to an operating system, and in particular, it relates to an automated process operation system and a process operation method.

### BACKGROUND

In recent years, with the significant improvement of hardware computing capability, the ability of machine learning algorithms in voice and image recognition has also been enhanced. In addition, with the successful training of neural networks, the limitless possibilities of artificial intelligence applications are being unlocked. Enterprises have also invested significant manpower and resources in the field of artificial intelligence technology. For example, the development of Robotic Process Automation (RPA) with artificial intelligence can complete daily tasks that were previously performed by manual labor.

Traditional robotic process automation (RPA) systems can be broadly divided into four major units to accomplish assigned tasks. These four units include: an artificial intelligence (AI) platform, an RPA platform, endpoint task robots, and a message queue service. The AI platform performs semantic analysis to identify the intent of the assigned task, and subsequently generates corresponding work tasks. The RPA platform writes the task execution workflows and error-handling steps. The endpoint task robots receive the tasks and execute them according to the predefined workflow. The message queue service facilitates information exchange between the platforms and the endpoint task robots. Through the close integration of these four major units, the automation tasks delivered by the enterprise can be effectively completed, thereby significantly reducing manual processing time, and human resources can focus on the value-added work of the enterprise.

In traditional robotic process automation systems, an independent orchestrator usually assigns tasks to endpoint task robots, so a machine with good hardware configuration must be prepared as the orchestrator. In addition, to ensure high availability, practical experience requires the preparation of more than one orchestrator machine. These machines serve as backups for one another and are responsible for assigning tasks to idle endpoint task robots. Platform managers must spend extra manpower and time on environment construction, so there will be a higher cost in the initial construction.

According to the practical experience of enterprises, various departments or business units may share the same orchestrator machine for task assignment. Therefore, when a new skill is completed and tested for online release, a manager must set up and inform the orchestrator machine of the endpoint task robot to which the skill will be delivered in the future. This undoubtedly places a burden on the manager and may even cause delays in online scheduling when the manager is busy.

Enterprises must respond immediately to rapidly changing demands. There are often sudden bursts of tasks that need to be executed urgently. Traditional robotic process automation systems must install services on endpoint task robots, and subsequent task assignments can only be performed after the endpoint task robots have completed registration with the orchestrator machine. This restricts the flexibility of expanding and retracting execution resources.

Traditional robotic process automation systems generally utilize Distributed Message Queues as their queue service. This architecture employs a publish-subscribe mechanism that partitions messages into multiple segments to increase message throughput. However, due to the addition of intermediary brokers in distributed message queues, problems such as message loss and duplicate message reception must be taken into consideration. If such situations occur due to connection problems, they may cause great losses to the enterprise.

### BRIEF SUMMARY

To solve the aforementioned problem, the present invention proposes a process operation system and method that divide the service construction process into five modules for management. The five modules are: a queue service (in conjunction with container technology), a connection module, a reporting module, a connection check module, and a notification module. It is through the interaction of these modules that the system can automate various routine yet critical maintenance procedures, as well as operation processes for enterprises.

An embodiment of the present invention provides a process operation system. The process operation system includes a queue service, a process operation platform, and an endpoint task robot. The queue service is operated with containerization technology. The process operation platform is configured to store received work tasks into a task queue of the queue service. The endpoint task robot has a connection module that is configured to establish a queue connection with the queue service by acquiring pre-generated connection management information from the queue service. A target work task is acquired via a queue channel based on a predefined access permission setting. Before establishing a connection with the queue service, the existence of the queue connection and the queue channel must be confirmed. If both are absent, the connection is established using the connection management information.

According to some aspects of the embodiment, the queue service is configured to use Kubernetes container technology in conjunction with RabbitMQ as the message queue service.

According to some aspects of the embodiment, the endpoint task robot further includes a reporting module, which is configured to report the completion of the target work task to the process operation system through an event bus architecture. In response to confirmation from the process operation system, the queue service notifies the endpoint task robot to delete the target work task from the queue service.

According to some aspects of the embodiment, the endpoint task robot further includes a connection check module. After the endpoint task robot is activated, the connection check module performs a connection check at a predetermined time period. When it is determined that the connection between the endpoint task robot and the queue service is disconnected, the connection check module reconstructs the connection through the connection module during the next check. When the endpoint task robot is activated for the first time, the connection check module does not perform the queue connection check. When the endpoint task robot is executing a work task, the connection check module does not perform a queue connection check.

According to some aspects of the embodiment, the endpoint task robot further includes a notification module. The notification module obtains the number of work tasks assigned to the endpoint task robot and issues a notification when the number of work tasks reaches a predefined upper limit. The notification module periodically sends heartbeat information to the process operation platform, and when the process operation platform detects that the endpoint task robot has failed to send the heartbeat information within the predetermined time interval, it issues an alert.

Another embodiment of the present invention provides a process operation method, including the following steps. A queue service integrated with containerization technology is utilized. A work task is received through a process operation platform and the work task is stored in a task queue of the queue service. An endpoint task robot with a connection module performs the following operations, It obtains pre-generated connection management information from the queue service to establish a connection between the endpoint task robot and the task queue of the queue service. Based on the predefined access permission setting for the endpoint task robot, it further connects to a corresponding channel within the task queue to acquire a target work task. Before establishing a connection between the endpoint task robot and the queue service, it checks the existence of connections to the task queue and the channel, and it proceeds with the connection based on the connection management information if both the task queue and the channel are found to be absent.

### BRIEF DESCRIPTION OF THE DRAWINGS

The present disclosure can be more fully understood by reading the subsequent detailed description and examples with references made to the accompanying drawings, wherein:

FIG. 1 is a schematic diagram of a process operation system 100 according to an embodiment of the present invention.

FIG. 2 is a schematic diagram showing the configuration of the endpoint task robot 30 of FIG. 1.

FIG. 3 illustrates an example of a processing flow of the connection module 301 of the endpoint task robot 30.

FIG. 4 illustrates an example of a processing flow of the reporting module 302 of the endpoint task robot 30.

FIG. 5 shows an example of the process for deleting completed work tasks performed by the endpoint task robot 30 in conjunction with the reporting module 302.

FIG. 6 shows an example of a processing flow of the connection check module 303 in the endpoint task robot 30.

FIG. 7 summarizes the overall processing flow of the process operation system 100 of the present embodiment.

### DETAILED DESCRIPTION

The following description is provided to enable a better understanding of the preferred embodiments of the present invention. It is intended to describe the fundamental spirit of the invention, but is not meant to limit the scope thereof. The actual scope of the invention shall be defined by the subsequent claims.

It should be understood that terms such as "comprise," "include," and the like used in this specification are intended to indicate the presence of certain technical features, numerical values, method steps, operations, components, and/or elements, but do not exclude the possibility of adding one or more other technical features, numerical values, method steps, operations, components, elements, or any combination thereof.

The terms such as "first," "second," "third," etc., used in the claims are employed solely to distinguish elements in the claims and are not intended to imply any priority, precedence, temporal order, or sequence of execution among the elements or method steps.

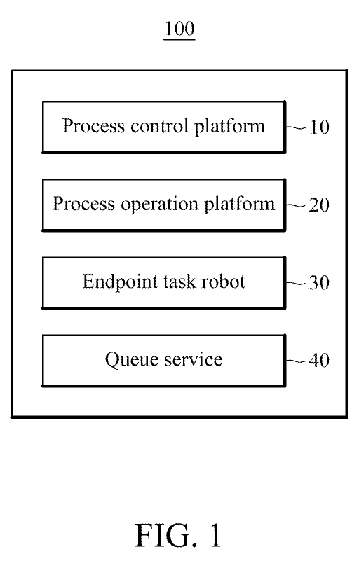

Please refer to FIG. 1. FIG. 1 is a schematic diagram of a process operation system 100 according to an embodiment of the present invention. In some embodiments, as shown in FIG. 1, the process operation system 100 includes a process control platform 10, a process operation platform 20, an endpoint task robot 30, and a queue service 40.

In some embodiments, the process control platform 10 may be implemented using a server, a notebook computer (i.e., laptop computer), or a desktop computer. In some embodiments, the process operation platform 20 may be implemented using a notebook computer (i.e., laptop computer), a desktop computer, or a virtual machine. In some embodiments, the process operation platform 20 is equipped with Robotic Process Automation (RPA) functionality.

In some embodiments, the endpoint task robot 30 may be implemented using a laptop computer (i.e., laptop computer), a desktop computer, or a virtual machine. In some embodiment, both physical machines (e.g., servers) and virtual machines (e.g., virtual machines installed on servers) may serve as the endpoint task robot 30.

In some embodiments, the process control platform 10, the process operation platform 20, and the endpoint task robot 30 each includes a processor, a microcontroller, a microprocessor, a digital signal processor (DSP), an application-specific integrated circuit (ASIC), or a logic circuit.

In some embodiments, the process control platform 10 includes a storage device. The storage device may be implemented using a read-only memory (ROM), flash memory, floppy disk, hard disk, optical disc, USB flash drive, magnetic tape, a database accessible from the internet, or any other storage medium with equivalent functionality which can be easily obtained by the person skilled in the art.

In some embodiments, the process control platform 10 is responsible for providing a user interface that allows a user to initiate a sequence of task-starting operations. The user interface may, for example, enable the user to start a task via a user device (such as a mobile phone, laptop computer, or desktop computer) by accessing a webpage, launching an application, or executing a scheduled task, for example sending an email to deliver task information.

In some embodiments, the process control platform 10 receives an email and obtains a file from the email. The process control platform 10 then extracts a task from the file. In some embodiments, the file may be, for example but not limited to, an Excel file. This Excel file may contain information such as part numbers, quantities, and models to be ordered, recorded by a purchasing personnel during the procurement process. The Excel file is then attached to the email and sent to the process control platform 10. After receiving the email, the process control platform 10 automatically detects the attached file, by recognizing text content in the email (including attachment fields), or by identifying icons corresponding to email fields, and downloads or opens the attached file. The process control platform 10 then applies known semantic analysis methods to extract a task (e.g., a procurement task) from the operational information, and releases it as a work task.

Here, the process control platform 10 may be, for example, an artificial intelligence (AI) platform capable of executing known semantic analysis methods, such as Natural Language Processing (NLP) algorithms, machine learning algorithms, text mining algorithms, parsing algorithms, and the like, to extract information and release work tasks.

In some embodiments, the queue service 40 utilizes container technology in combination with a container resource orchestration platform to implement the required queue service and to provide information necessary for subsequent process operations, such as endpoints, accounts, and passwords for information exchange. In this embodiment, the queue service 40 is established by integrating the RabbitMQ queue service using container technology. In this embodiment, RabbitMQ is selected because it supports multiple communication protocols, offers comprehensive features and better performance, more suitable for enterprise-level development.

Container technology, which does not include an operating system image, has advantages over deploying services on physical or virtual hosts, such as requiring fewer resources and offering higher efficiency. In addition, deploying services using the same application ensures consistent service specifications, making it easier to expand and manage. In this embodiment, the container technology may be, but is not limited to, implemented using the Kubernetes container resource orchestration platform. The Kubernetes container resource orchestration platform can automatically detect and manage the state of each container; in the case of resource shortages or abnormalities, it can immediately perform automatic expanding, or delete and then recreate containers, thereby ensuring uninterrupted service and reducing the burden on system administrators.

In some embodiments, the process operation platform 20 receives work tasks from the process control platform 10 and stores them in the task queue of the queue service 40.

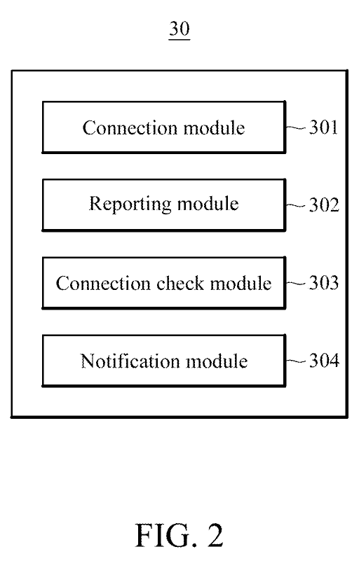

In some embodiments, as shown in FIG. 2, the endpoint task robot 30 includes a connection module 301, a reporting module 302, a connection check module 303, and a notification module 304. The operations of each module are described in detail below.

### Connection Module

The process operation system 100 in this embodiment can be deployed across various business units and support departments within an enterprise. Accordingly, for example but not limited to, Active Directory (AD) accounts (also referred to as digital employee accounts) may be used to distinguish each endpoint task robot 30. When an endpoint task robot is initially activated and verified as a legitimate digital employee through authorization procedures, it may use its connection module 301 and apply encryption/decryption methods to obtain pre-generated connection management information (Connection Factory) from the queue service 40, thereby establishing a connection. The connection management information is used to create a connection and a channel with the server of the queue service 40 (e.g., a RabbitMQ server). The channel is the actual pathway for sending and receiving messages, whereas the connection refers to the network link between the RabbitMQ client (i.e., the endpoint task robot 30) and the RabbitMQ server (i.e., the queue service 40).

Sharing a single queue channel among multiple endpoint robots carries a higher risk of errors. Therefore, in some embodiments, access permissions for endpoint task robots (digital employees) are differentiated, meaning that each endpoint task robot (digital employee) independently connects to its designated queue channel. For example, the accessible channel can be determined based on the business unit whose tasks the endpoint robot 30 is intended to process. In this manner, when a single endpoint task robot encounters an error, it can be individually deleted and re-established without affecting others, thereby significantly reducing the impact level. For the user, tasks for each endpoint task robot (digital employee) are independently configured, making monitoring and management more convenient while also enhancing overall security.

Before each connection, the endpoint task robot 30 must verify the existence of both the queue connection and the queue channel. If neither exists, it may establish a new connection based on the predefined connection management information. However, if a connection and channel are already present, they must be deleted in order to ensure connection uniqueness. This prevents multiple queue connections that could cause the endpoint robot to execute multiple tasks simultaneously and result in task failures.

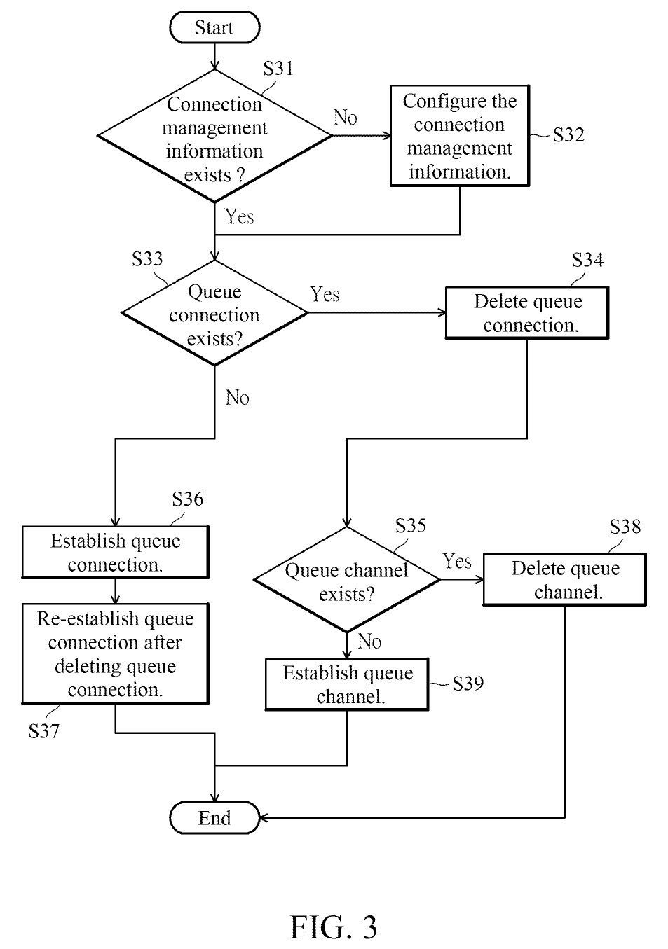

FIG. 3 illustrates an example of the processing flow of the connection module 301 of the endpoint task robot 30. First, the connection module 301 checks whether the connection management information exists (step S31). If it does not exist (step S31: No), for example but not limited to this, the connection module notifies the process operation system 100 to configure the connection management information (Step S32), and then proceeds to step S33 to determine whether the queue connection exists. If the connection management information already exists (step S31: Yes), the connection module 31 proceeds directly to check whether the queue connection exists (step S33). If the queue connection exists (step S33: Yes), meaning the connection is currently open (active), then the queue connection is deleted (Step S34), and the process proceeds to step S35. If the queue connection does not exist (step S33: No), the process proceeds to step S36.

In step S36, the connection module 301 establishes a queue connection with the queue service 40. Then, in step S37, the connection module 301 first deletes any existing queue channel and then re-establishes the queue channel to complete the connection process.

In step S35, the connection module 301 checks whether the queue channel exists. If it exists (step S35: Yes), the queue channel is then deleted (step S38). If the queue channel does not exist (step S35: No), a queue channel is created (step S39).

The endpoint task robot 30 (digital employee) may further, for example but not limited to, configure a QoS (Quality of Service) mechanism within the connection module 301. The QoS mechanism ensures that only one message is retrieved per connection at a time, and that the message cannot be accessed by other endpoint task robots until the message has been acknowledged by the receiving endpoint task robot. This guarantees that each work task is executed from start to finish by a single endpoint task robot. It should be noted that when a work task is not acknowledged within a certain period of time and the original endpoint task robot that performs the work task is disconnected, the work task will be returned to the queue service after a period of time. The returned work task can then be reassigned to another available endpoint task robot. This mechanism allows for greater operational flexibility and enables other idle digital employees to take over in the event of a failure.

### Reporting Module

In this embodiment, after the endpoint task robot 30 completes its automated operation according to the predefined workflow, it reports the execution status to the process control platform 10 (the artificial intelligence platform) through the reporting module 302. The process control platform 10 then relays the execution record and related information to the user. After the process control platform 10 makes final confirmation, the endpoint task robot 30 is instructed to delete the completed task from the queue service.

The stable operation of the endpoint task robot 30 relies on the queue service 40 for information exchange. In this embodiment, the reporting module 302 focuses on ensuring the correctness and availability of messages sent to the queue service 40. Although API (Application Programming Interface) is fast in response and has a reporting mechanism, when there are too many endpoint task robots 30 (digital employees), there is a high probability that too many connections will be called to the API, resulting in blockage and delay. Therefore, in some embodiments, the reporting module 302 adopts an asynchronous queue processing mechanism and incorporates the “MassTransit” framework. The MassTransit framework supports various message exchange services and offers robust and comprehensive message modes, including publishing/subscribing, Sagas, and support for eventual consistency. The MassTransit framework also provides essential inter-endpoint solutions such as exception handling, retry mechanisms, and lifecycle management. By using this framework, the complexity of message exchange applications is significantly reduced.

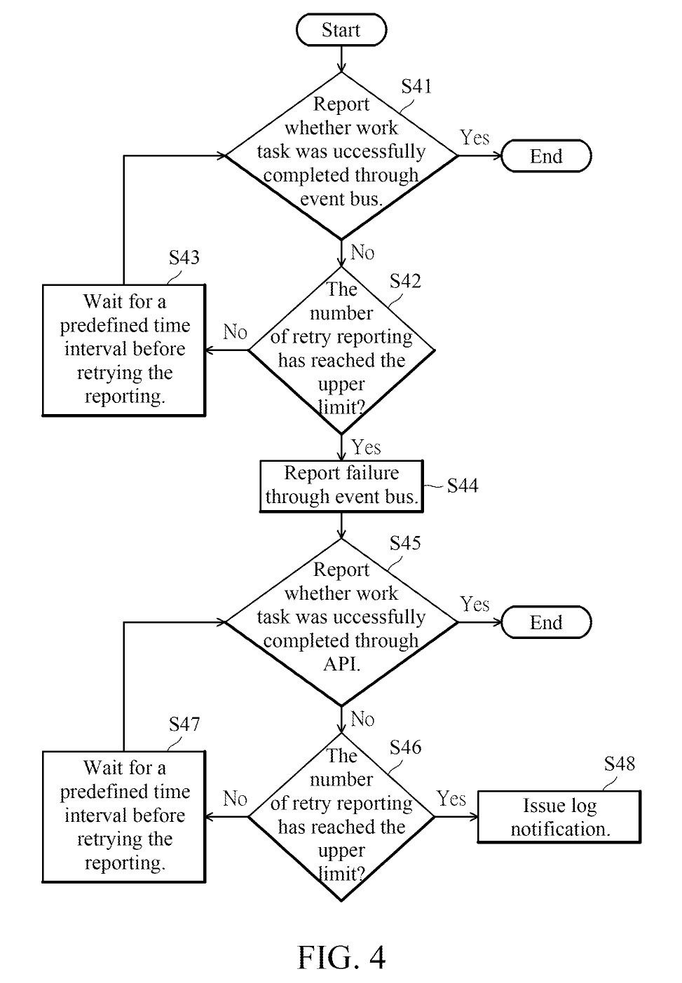

FIG. 4 illustrates an example of a processing flow of the reporting module 302 of the endpoint task robot 30.

An Event Bus is an architecture used for transmitting messages or events between different components or services. It allows various application components or modules to asynchronously send and receive events, that is to communicate asynchronously, without needing to mutual knowledge or be directly coupled to each other. Due to its decoupling capability, event publishers and subscribers only need to rely on the event's identifier or content to interact with one another.

The reporting module 302 of the endpoint task robot 30 may use the event bus to transmit messages or events. In some embodiments, the endpoint task robot 30 reports the execution result of its assigned work task to the process control platform 10 (artificial intelligence platform) through the event bus (Step S41), indicating whether the work task was successfully completed. If the work task was successfully completed (step S41: Yes), the reporting process ends. If the work task was not successfully completed (step S41: No), the endpoint task robot 30 will retry the reporting process (steps S42 and S43). In step S42, if the number of retry attempts has not reached the upper limit (step S42: No), the reporting module 302 waits for a predefined time interval, such as 5 seconds (step S43) before returning to step S41 to retry the report. If the maximum number of retry attempts has been reached (step S42: Yes), it indicates a failure in reporting through the event bus (step S44), and the reporting module 302 then switches to report the task execution result through an API.

In step S45, if the report through the API is successfully delivered (step S45: Yes), the reporting process ends. If the report through the API fails (step S45: No), the reporting module 302 retries the reporting process (steps S46 and S47). In step S46, if the number of retry attempts has not yet reached the maximum limit (step S46: No), the reporting module 302 waits for a predefined period, for example, 5 seconds (step S47) before returning to step S45 to retry the reporting process. If the retry limit has been reached (step S46: Yes), it indicates a failure in reporting through the API. In such case, a log notification is issued, and the reporting process is terminated (Step S48).

After the endpoint task robot 30 (digital employee) finishes executing a work task and completes the reporting process, it must wait for a confirmation from the process control platform 10 (artificial intelligence platform) acknowledging receipt of the report, thereby ensuring data synchronization, which facilitates subsequent operations such as notification handling, error tracking, and statistical analysis. Once the endpoint task robot 30 receives a task completion confirmation sent through the queue service 40 from the process control platform 10, the endpoint task robot 30 must connect to the queue service 40 to remove the completed work task. This step ensures that the same work task will not be executed again. If the removal step repeatedly fails, it is more possible due to a disrupted connection with the queue service 40. At this moment, the endpoint task robot 30 will stop attempting further deletions and instead re-establish the connection using the connection module 301, thereby preventing execution delays caused by the robot becoming idle.

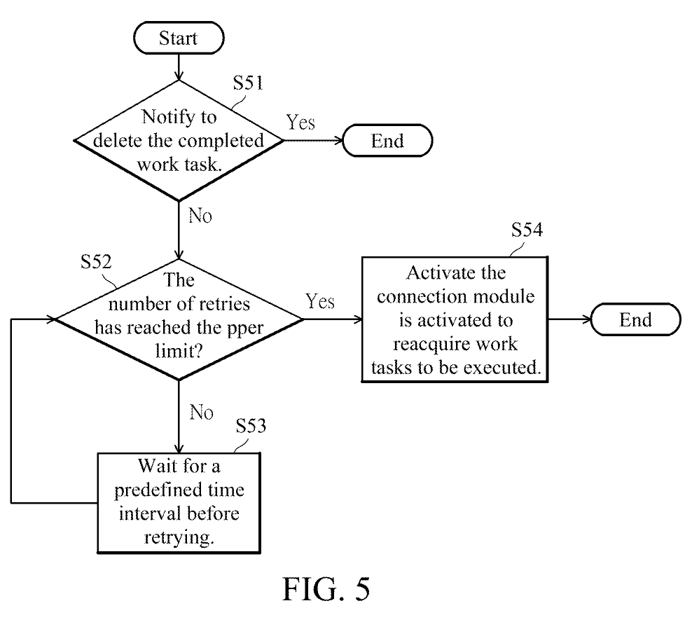

FIG. 5 shows an example of the deletion process for the completed work task performed by the endpoint task robot 30 in conjunction with the reporting module 302. The process control platform 10, through the queue service 40, notifies the endpoint task robot 30 to delete the completed work task. In step S51, if the reporting module 302 responds that the deletion was successful (step S51: Yes), the deletion process ends. If the reporting module 302 does not respond with a successful deletion (step S51: No), the endpoint task robot 30 initiates a retry operation (steps S52 and S53). In step S52, the reporting module 302 checks whether the number of retries has reached the upper limit. If not (Step S52: No), the endpoint task robot 30 waits for a predetermined time, such as 5 seconds, and then retries the deletion process (Step S53). If the retry count has reached the upper limit (Step S52: Yes), the connection module 301 is activated to reacquire work tasks to be executed (Step S54). Then, the deletion process ends.

### Connection check module

In some embodiments, the endpoint task robot 30 includes a connection check module 303, which provides a proper verification mechanism and activates the connection module 301 at an appropriate timing when a disconnection occurs.

In this embodiment, when the endpoint task robot 30 (digital employee) is activated, the connection check module 303 immediately performs a connection check operation, for example but not limited to, once every three minutes, to ensure the status of the queue connection. It should be noted that because the connection is just established when the endpoint task robot 30 is first started, performing a connection check at this moment would unnecessarily waste computing resources. Therefore, the connection check module 303 does not perform the connection check during the initial startup of the endpoint task robot 30. In addition, if the endpoint task robot 30 establishes a connection while executing a work task, it is considered to be in an idle state. This could lead to the endpoint task robot 30 acquiring a new work task to execute, resulting in concurrent execution errors and an increased risk of malfunction. Hence, the connection check module 303 also does not perform connection checks during task execution. If the endpoint task robot 30 is actually disconnected, the reconnection can be triggered either during the next scheduled check (e.g., after 3 minutes) or during the operation of the reporting module 302.

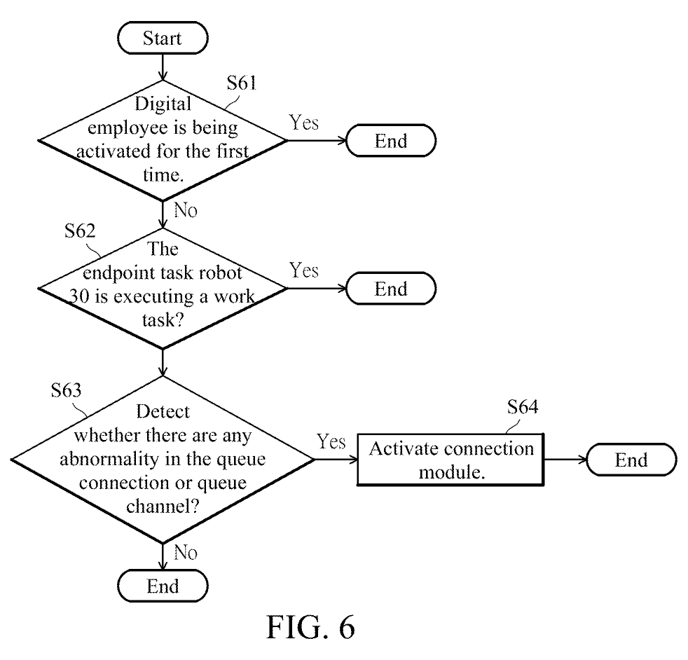

FIG. 6 illustrates an example of the processing flow of the connection check module 303 within the endpoint task robot 30. In this embodiment, after the endpoint task robot 30 is activated, the connection check module 303 performs periodic checks of the queue connection at predetermined intervals, for example, verifying the connection between the endpoint task robot 30 and the queue service 40. In step S61, when the endpoint task robot 30 (digital employee) is being activated for the first time (step S61: Yes), the connection check module 303 does not perform the queue connection check. When the endpoint task robot 30 is not being activated for the first time (step S61: No), then the connection check module 303 checks whether the endpoint task robot 30 is currently executing a work task (step S62). If the endpoint task robot 30 is executing a work task (step S62: Yes), no connection check is performed. If the endpoint task robot 30 is not executing a work task (Step S62: No), the connection check module 303 detects whether there are any abnormalities in the queue connection or queue channel (Step S63). If abnormality is detected (step S63: Yes), the connection module 301 is activated to establish the connection (step S64), otherwise, the current connection check process ends.

### Notification Module

In some embodiments, the process operation system 100 implements a load-balancing mechanism within the queue service 40 by distinguishing endpoint task robots 30 (digital employees) based on access permissions. The number of messages in the queue endpoint corresponding to each endpoint task robot represents the number of work tasks currently assigned to that digital employee.

The upper limit on the number of messages in a queue endpoint (i.e., the number of work tasks for an endpoint task robot 30 to execute) can be flexibly adjusted based on the requirements of the digital employee's manager. The endpoint task robot 30 also regularly checks the message count in its corresponding queue endpoint. When the number of messages reaches the defined limit, the notification module 304 issues a notification to the process operation system 100 or the relevant management personnel. This mechanism allows managers to be informed when there is an excessive backlog of tasks, indicating that additional resources may be needed to process them.

After activation, the endpoint task robot 30 (digital employee) periodically sends a heartbeat message to the queue service 40, for example, every fifteen minutes, containing information such as its currently executing task, version, and timestamp. The process operation platform 20 (RPA platform) includes a continuously running service or routine that monitors the queue service 40 and writes the received messages into a database. when the process operation platform 20 detects that any digital employee has not sent a heartbeat message within the expected time period, it will notify the relevant management personnel via email, prompting them to inspect or restart the digital employee.

### Process Operation System

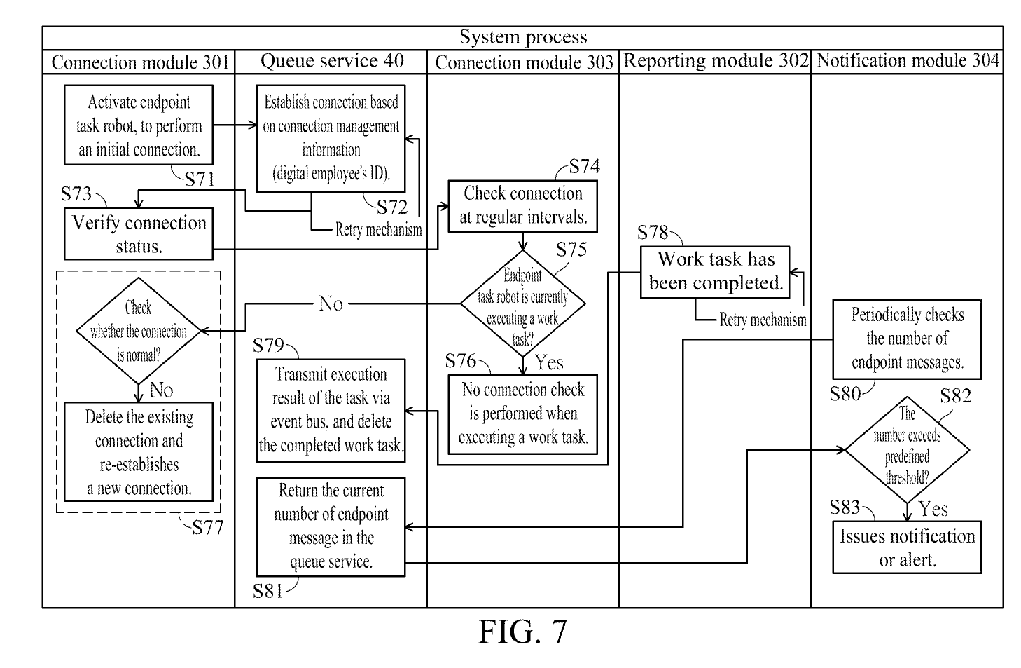

FIG. 7 provides a summary illustration of the overall processing flow within the process operation system 100 of this embodiment, showing how the connection module 301, connection check module 303, reporting module 302, and notification module 304 of the endpoint task robot 30 interact with the queue service 40.

In step S71, the endpoint task robot 30 is activated and performs an initial connection through the connection module 301. In step S72, the queue service 40 provides the connection module 301 with connection management information and the digital employee’s identification (ID), enabling the establishment of the connection. A retry mechanism is included in this step to ensure a successful connection. In step S73, the connection module 301 further verifies the connection status. Subsequently, at regular intervals. For example, every three minutes, in Step S74, the connection check module 302 performs a connection check. In step S75, when the connection check module 302 determines that the endpoint task robot 30 is currently executing a work task (step S75: Yes), no connection check is performed (step S76). when the connection check module 302 determines that the endpoint task robot 30 is not executing any work task (step S75: No) and finds that the connection is abnormal, the connection module 301 deletes the existing connection and re-establishes a new connection with the queue service 40 (Step S77).

In step S78, the reporting module 302 continuously monitors whether the endpoint task robot 30 has completed the assigned work task according to the predefined workflow. In step S79, the execution result of the task is transmitted to the queue service 40 via the Event Bus, and the completed task is then deleted from the queue service 40.

In step S80, the endpoint task robot 30 periodically checks the number of endpoint messages (i.e., the number of the work tasks to be executed) in the queue service 40, for example through the notification module 303. In step S81, the queue service 40 returns the current number of endpoint message in the queue service 40. If the number of endpoint messages exceeds the predefined threshold (step S82), the notification module 304 issues a notification or alert (Step S83).

The process operation system and method of the present embodiment differ from the conventional technologies primarily in the manner of work task acquisition. In the present invention, work tasks are acquired in a bottom-up approach, where idle endpoint task robots connect to the task queue service and retrieve work tasks on their own. In contrast, the traditional technologies typically rely on an independent orchestrator to assign work tasks to endpoint task robots.

In addition, the process operation system and method of the present invention has following advantages such as lower initial deployment cost, rigorous control for access permission, and ease of scaling execution resources. The process operation system and method of the present invention adopts a suitable queue service with features including asynchronous communication and a decoupling architecture. Asynchronous communication allows users to dispatch tasks and endpoint task robots to execute them in an asynchronous manner. The decoupling architecture enables the queues to be independently partitioned so when a specific queue endpoint encounters an error and requires removal or reconstruction, the other queue endpoints remain unaffected. This greatly enhances system stability and maintainability.

To enhance service availability, the queue service adopts containerization technology along with a container orchestration service. These technologies can automatically monitor the queue service and rebuild the queue service in the event of a failure. In addition, the endpoint task robots are equipped with robust error-handling and retry mechanisms, allowing them to recover from exceptions occurring during task acquisition or connection processes. The process operation system and method of the present invention also implement a monitoring and alert mechanism. when an endpoint task robot fails to respond within a predetermined time period, or when the number of tasks in the queue exceeds a defined threshold, the process operation system will notify the relevant administrators. This design aligns with practical enterprise operations and ensures efficient workload management and reliable task processing.

While the present invention has been disclosed in terms of preferred embodiments, it is not limited thereto. Various modifications and variations may be made by those skilled in the art without departing from the spirit and scope of the invention. Therefore, the scope of protection of the present invention shall be defined by the appended claims.

What is claimed is:

1. A process operation system, comprising:
a queue service, operated with containerization technology;
a process operation platform, configured to store received work tasks into a task queue of the queue service; and
an endpoint task robot, having a connection module configured to:
establish a queue connection with the queue service by acquiring pre-generated connection management information from the queue service;
acquire a target work task via a queue channel based on predefined access permission setting; and
before establishing a connection with the queue service, check for the existence of the queue connection and the queue channel, and if both are absent, establish the connection using the connection management information.

2. The process operation system as claimed in claim 1, wherein the queue service is configured to use Kubernetes container technology in conjunction with RabbitMQ as the message queue service.

3. The process operation system as claimed in claim 1, wherein the endpoint task robot further comprises a reporting module configured to:
report the completion of the target work task to the process operation system through an event bus architecture; and
in response to confirmation by the process operation system, notify the endpoint task robot via the queue service to delete the target work task from the queue service.

4. The process operation system as claimed in claim 3, wherein the endpoint task robot further comprises a connection check module, wherein:
after the endpoint task robot is activated, the connection check module performs a connection check at a predetermined time period;
when it is determined that the connection between the endpoint task robot and the queue service is disconnected, the connection check module reconstructs the connection through the connection module during the next check;
when the endpoint task robot is activated for the first time, the connection check module does not perform the queue connection check; and
when the endpoint task robot is executing a work task, the connection check module does not perform the queue connection check.

5. The process operation system as claimed in claim 1, wherein the endpoint task robot further comprises a notification module, wherein
the notification module obtains the number of work tasks assigned to the endpoint task robot and issues a notification when the number of work tasks reaches a predefined upper limit; and
the notification module periodically sends heartbeat information to the process operation platform, and when the process operation platform detects that the endpoint task robot has failed to send the heartbeat information within the predetermined time interval, it issues an alert.

6. The process operation system as claimed in claim 3, further comprising a process control platform configured to receive operation information, extract a task from the operation information using a semantic analysis method, and issue the task as the work task;
wherein the process control platform receives a report from the endpoint task robot and, after confirmation, instructs the endpoint task robot to delete the target work task from the task queue.

7. A process operation method, comprising:
utilizing a queue service integrated with containerization technology;
receiving a work task through a process operation platform and storing the work task in a task queue of the queue service; and
using an endpoint task robot with a connection module to perform the following operations:
obtaining pre-generated connection management information from the queue service to establish a connection between the endpoint task robot and the task queue of the queue service;
based on the predefined access permission setting for the endpoint task robot, further connecting to a corresponding channel within the task queue to acquire a target work task; and
before establishing a connection between the endpoint task robot and the queue service, checking the existence of connections to the task queue and the channel, and proceeding with the connection based on the connection management information if both the task queue and the channel are found to be absent.

8. The process operation method as claimed in claim 7,
wherein a reporting module of the endpoint task robot is used to perform the following operations:
reporting the completion of the target work task via an event bus architecture; and
receiving a notification from the queue service to instruct the endpoint task robot to delete the target work task from the task queue.

9. The process operation method as claimed in claim 8, wherein, after the endpoint task robot is activated, a connection check module of the endpoint task robot performs a connection check at a predetermined interval;
when it is determined that the connection between the endpoint task robot and the queue service is disconnected, the connection check module re-establishes the connection through the connection module during the next check;
when the endpoint task robot is activated for the first time, the connection check module does not perform the connection check; and
when the endpoint task robot is executing a work task, the connection check module does not perform the connection check.

10. The process operation method as claimed in claim 7, wherein a notification module of the endpoint task robot is used to perform the following operations:
obtaining the number of work tasks assigned to the endpoint task robot, and issuing a notification when the number of work tasks reaches a predefined upper limit; and
periodically transmitting heartbeat information to the process operation platform, and then issuing an alert when the process operation platform detects that the endpoint task robot has failed to send the heartbeat information within the predetermined time interval.
